(19) United States
(12) Patent Application Publication
(10) Pub. No.: US 2026/0263991 A1
(43) Pub. Date: Sep. 10, 2026

(54) CARBON DIOXIDE ABSORBENT USING AQUEOUS POTASSIUM CARBONATE SOLUTION, PROCESS OF CAPTURING CARBON DIOXIDE AND SYSTEM OF CAPTURING CARBON DIOXIDE USING THE SAME

(71) Applicants: Samsung Electronics Co., Ltd., Suwon-si (KR); Gwangju Institute of Science and Technology, Gwangju (KR)

(72) Inventors: Seung Hoon Song, Suwon-si (KR); Ji-Woong Park, Gwangju (KR); Jae-Young Kim, Suwon-si (KR); Jinha Kim, Suwon-si (KR); Woo Yong Shim, Suwon-si (KR); Dawoon Jeong, Gwangju (KR); Yu Kyung Jung, Suwon-si (KR); Marbert PINQUE, Gwangju (KR)

(21) Appl. No.: 19/466,900

(22) Filed: Feb. 2, 2026

(30) Foreign Application Priority Data
Feb. 17, 2025 (KR) 10-2025-0020380

(51) Int. Cl. B01D 53/14; B01D 53/18

(52) U.S. Cl. CPC B01D 53/1475; B01D 53/1406; B01D 53/1425; B01D 53/1493; B01D 53/18; B01D 2252/103; B01D 2252/602; B01D 2257/504

(57) ABSTRACT

A carbon dioxide absorbent using an aqueous potassium carbonate solution, a carbon dioxide capture process using the carbon dioxide absorbent, and a carbon dioxide capture system. The carbon dioxide absorbent includes an aqueous potassium carbonate solution including a carbonic anhydrase activity enhancer; and one or more nanoporous structures, where the one or more nanoporous covalently bonded structure includes carbonic anhydrase. The carbonic anhydrase activity enhancer includes a secondary amine compound, where the secondary amine compound may be present at a concentration of about 20 millimolar to about 90 millimolar in the aqueous potassium carbonate solution.

### CROSS-REFERENCE TO RELATED APPLICATION

This application is based on and claims priority to Korean Patent Application No. 10-2025-0020380, filed on Feb. 17, 2025, in the Korean Intellectual Property Office, and all the benefits accruing therefrom under 35 U.S.C. § 119, the content of which in its entirety is incorporated by reference herein.

### BACKGROUND

### 1. Field

The present disclosure relates to a carbon dioxide absorbent using an aqueous potassium carbonate solution, a carbon dioxide capture process using the carbon dioxide absorbent, and a carbon dioxide capture system.

### 2. Description of the Related Art

Carbon dioxide (CO₂) is a major component of greenhouse gases, and technologies capable of efficiently capturing CO₂ are essential to reduce CO₂ emissions. Aqueous amine solutions are commonly used as carbon dioxide (CO₂) absorbents. Although aqueous amine solutions offer high efficiency and fast kinetics for carbon dioxide (CO₂) absorption, such solutions exhibit strong binding affinity for CO₂, which results in high energy consumption during the desorption of CO₂ and regeneration processing of the absorbents. Moreover, the amine-based solutions tend to be highly toxic and potentially cause equipment corrosion. Accordingly, there is a need for a carbon dioxide (CO₂) absorbent that is more environmentally friendly and/or consumes less energy.

An absorbent based on an aqueous potassium carbonate (K₂CO₃) solution is less toxic and environmentally friendly, and because it has a lower heat of absorption (609 kilojoules per kilogram (kJ/kg)) than amines (1,919 kJ/kg), it can absorb carbon dioxide (CO₂) at low temperatures below 60° C. In addition, an aqueous potassium carbonate (K₂CO₃) solution enables carbon dioxide (CO₂) desorption at relatively low temperatures, e.g., of 80° C. to 100° C., which can reduce energy consumption. However, an aqueous potassium carbonate (K₂CO₃) solution exhibits a slower carbon dioxide (CO₂) absorption rate as compared to other CO₂ absorbents, and thus, there is a need for technologies that can improve upon the rate.

Accordingly, there is a need for a carbon dioxide absorbent using an aqueous potassium carbonate solution that enables CO₂ absorption even at elevated temperatures and allows repeated regeneration with minimal change in absorption capacity, as well as a carbon dioxide capture process and system which use the carbon dioxide absorbent.

### SUMMARY

Provided is a carbon dioxide absorbent using an aqueous potassium carbonate solution that enables CO₂ absorption even at elevated temperatures and allows repeated regeneration with minimal reduction in CO₂ absorption capacity.

Provided is a carbon dioxide capture process using the carbon dioxide absorbent.

Provided is a carbon dioxide capture system using the carbon dioxide absorbent.

Additional aspects will be set forth in part in the description which follows and, in part, will be apparent from the description, or may be learned by practice of the presented embodiments of the disclosure.

According to an aspect of the disclosure, a carbon dioxide absorbent using an aqueous potassium carbonate solution includes
an aqueous potassium carbonate solution including a carbonic anhydrase activity enhancer and
one or more nanoporous structures, e.g., covalently bonded structures,
wherein the one or more nanoporous structures include carbonic anhydrase,
wherein the carbonic anhydrase activity enhancer includes a secondary amine compound, and the secondary amine compound is present in the aqueous potassium carbonate solution at a concentration of about 20 millimolar (mM) to about 90 mM.

According to another aspect of the disclosure, a carbon dioxide capture process using a carbon dioxide absorbent includes:
absorbing a carbon dioxide using a carbon dioxide absorbent; and
desorbing the carbon dioxide from the carbon dioxide absorbent;
wherein the carbon dioxide absorbent includes
an aqueous potassium carbonate solution including a carbonic anhydrase activity enhancer and
one or more nanoporous structures, wherein the one or more nanoporous structure includes carbonic anhydrase,
wherein the carbonic anhydrase activity enhancer includes a secondary amine compound, and
wherein the secondary amine compound is present in the aqueous potassium carbonate solution at a concentration of about 20 mM to about 90 mM.

According to another aspect of the disclosure, a carbon dioxide capture system includes
an absorber configured to generate a bicarbonate ion (HCO₃⁻)-containing aqueous solution by reacting carbon dioxide in exhaust gas with a first carbon dioxide absorbent using an aqueous potassium carbonate solution and
a stripper configured to receive the generated bicarbonate ion-containing aqueous solution through piping connected to the absorber, and to regenerate the solution as a fresh aqueous potassium carbonate solution by separating and removing carbon dioxide through heating or depressurization,
wherein the carbon dioxide absorbent includes
the aqueous potassium carbonate solution containing a carbonic anhydrase activity enhancer, and
one or more nanoporous covalently bonded structures,
wherein the one or more nanoporous structure includes carbonic anhydrase,
the carbonic anhydrase activity enhancer includes a secondary amine compound, and the secondary amine compound is present in the aqueous potassium carbonate solution at a concentration of about 20 mM to about 90 mM.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram schematically illustrating a reaction mechanism of carbonic anhydrase (CA), according to an embodiment;

FIG. 2 is a schematic diagram illustrating a process of manufacturing a nanoporous structure, e.g., a covalently bonded structure, membrane according to an embodiment;

FIG. 3 is schematic diagram showing a reactor in which a carbon dioxide absorbent including an aqueous potassium carbonate solution according to an embodiment is disposed;

FIGS. 4A and 4B show results of analyzing, by scanning electron microscopy-energy dispersive x-ray spectroscopy (SEM-EDS), a cross-section of a nanoporous covalently bonded structure membrane on which carbonic anhydrase (bCA) is immobilized on a nanoporous structure membrane of Preparation Example 1;

FIG. 5 shows results of measuring the content of carbonic anhydrase (bCA) immobilized on a nanoporous structure membrane, fabricated using a membrane of Preparation Example 1, according to permeation time (hour, hr) of an aqueous bCA solution used for immobilization, and also a flow rate (liters per square meter per hour, Lm-2 h⁻¹) of membrane during an immobilization process;

FIG. 6 is schematic diagram illustrating process for repeatedly reusing a carbon dioxide absorbent using an aqueous potassium carbonate solution, according to an embodiment;

FIG. 7 shows experimental results for amount of CO₂ absorbed per mole of potassium carbonate over time in each cycle, when a carbon dioxide absorbent including an aqueous potassium carbonate solution of Example 1 was reused (or recycled) up to ten cycles according to procedure shown in FIG. 6;

FIG. 8 shows results of measuring the amount of CO₂ absorbed per mole of potassium carbonate over 2 hours at 30° C., 50° C., or 70° C., for an aqueous potassium carbonate solution of Reference Example 1, CO₂ absorbents using potassium carbonate solutions of Comparative Examples 1, 2, and 3, and a CO₂ absorbent using potassium carbonate solution of Example 1;

FIG. 9 shows results of measuring the amount of CO₂ absorbed per mole of potassium carbonate over 2 hours at 30° C., for CO₂ absorbents using aqueous potassium carbonate solutions of Reference Examples 1-5, Comparative Examples 3-5, Example 1, and Example 4; and

FIG. 10 is schematic diagram of a carbon dioxide capture system using a carbon dioxide absorbent according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all a combination of one or more of the associated listed items. Expressions such as “at least one of,” when preceding a list of elements, modify the entire list of elements and do not modify the individual elements of the list.

The present inventive concept described below may be subject to various modifications and may have various embodiments, and specific embodiments are illustrated in the drawings and described in detail in the detailed description. However, this is not intended to limit the present inventive concept to specific embodiments, and should be understood to include all modifications, equivalents, or substitutes included within the technical scope of the present inventive concept.

The terminology used herein is for the purpose of describing particular embodiments only and is not intended to be limiting of the present inventive concept. As used herein, the singular forms are intended to include the plural forms as well, unless the context clearly indicates otherwise.

In the present specification, the expression “at least one,” or “one or more,” preceding a list of elements does not mean that it supplements the entire list of elements nor that it supplements the individual elements of the description. In the present specification, the term “combination,” unless otherwise specified, includes mixtures, alloys, reaction products, and the like. In the present specification, the term “comprising,” or “including”, unless otherwise specified, means that other components may be further included, not excluding other components. “Or,” unless otherwise specified, means “and/or”.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Throughout this specification, expressions such as “one embodiment” or “an embodiment” indicate that a particular feature described in connection with the embodiment is included in at least one embodiment described herein, and may or may not be present in other embodiments. Furthermore, it should be understood that the described elements may be combined in any suitable manner in various embodiments.

Unless otherwise stated, all percentages, parts, ratios, etc., are by weight. Also, when a quantity, concentration, or other value or parameter is given as either a range, preferred range, or a list of preferred upper preferable values and lower preferable values, this is to be understood as specifically disclosing all ranges formed from any pair of any upper range limit or preferred value and any lower range limit or preferred value, regardless of whether ranges are separately disclosed.

Where a range of numerical values is referred to herein, unless otherwise stated, the range is intended to include the endpoints thereof, and all integers and fractions within the range. The scope of the present disclosure is not intended to be limited to the specific values recited when defining a range.

Unless otherwise specified, the unit “parts by weight” refers to the weight ratio between each component, and the unit “parts by mass” refers to the value obtained by converting the weight ratio between each component to solid content.

The term millimolar (mM) refers to a concentration of millimoles of a compound (or solute) in one liter of solution. For example, 10 millimolar (mM) of an amine refers to a concentration of 10 millimoles of the amine in 1 liter of solution.

As used herein, “about” includes the stated value and means within an acceptable range of deviation for the particular value as determined by one of ordinary skill in the art, considering the measurement in question and the error associated with measuring the particular quantity (i.e., the limitations of the measurement system). For example, “about” can mean within one or more standard deviations, or within ±10%, ±5%, or ±3% of the specified value.

Unless otherwise defined, all terms (including technical and scientific terms) used herein have the same meaning as commonly understood by one of ordinary skill in the art to which this disclosure belongs. Furthermore, it will be understood that terms, such as those defined in commonly used dictionaries, should be interpreted as having a meaning that is consistent with their meaning in the context of the relevant art and the present disclosure, and will not be interpreted in an idealized manner. Or these terms should not be interpreted in an overly formal sense.

Exemplary embodiments are described herein with reference to cross-sectional illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions illustrated herein but are to include deviations in shapes that result, for example, from manufacturing. For example, a region illustrated or described as flat may, typically, have rough and/or nonlinear features. Also, angles illustrated as sharp may be rounded. Thus, the regions illustrated in the figures are schematic in nature and their shapes are not intended to illustrate the precise shape of a region and are not intended to limit the scope of the claims.

Common amine-based carbon dioxide (CO₂) absorbents include aqueous amine solutions such as monoethanolamine (MEA), a primary amine compound; diethanolamine (DEA), a secondary amine compound; N-methyldiethanolamine (MDEA), a tertiary amine compound; and 2-amino-2-methyl-1-propanol (AMP), a sterically hindered amine compound. However, these aqueous amine solutions may undergo performance degradation as irreversible amine compound are formed due to impurities such as sulfur dioxide (SO₂), oxygen (O₂), and nitrogen oxides (NOx) in combustion exhaust gas, thereby consuming the active amine components. As a result, systems using aqueous amine solutions may suffer from corrosion, and due to the high thermal and chemical stability of carbamates formed by the reaction with carbon dioxide, the regeneration process requires temperatures higher than or equal to 120° C., leading to excessive energy consumption. In addition, alkanolamines volatilize excessively at temperatures higher than or equal to 120° C., resulting in loss of the amine compound. Accordingly, the carbon dioxide absorbent must be replenished, and due to its low vapor pressure, contamination of the carbon dioxide during reuse may occur.

Carbon dioxide (CO₂) absorbents utilizing carbonic anhydrase (CA) has been shown to enhance the CO₂ absorption rate, and are of interest. However, when carbonic anhydrase is used as a CO₂ absorbent without immobilization, there are stability issues such as loss of enzymatic activity due to chemical reactions, and denaturation, aggregation, precipitation, or loss of the enzyme during prolonged use. Accordingly, for repeated adsorption and desorption (or recycle) operations, it is essential to immobilize the carbonic anhydrase enzyme. General examples of enzyme immobilization processes include physical or chemical adsorption or binding methods. However, conventional enzyme immobilization methods alone are insufficient to ensure long-term activity and/or stability at elevated temperatures.

In view of these issues, the inventors of the present disclosure propose a carbon dioxide absorbent using an aqueous potassium carbonate solution in which carbonic anhydrase (CA) is immobilized on a nanoporous structure, along with a carbon dioxide capture process and a carbon dioxide capture system using the carbon dioxide absorbent.

### Carbon Dioxide Absorbent Using Aqueous Potassium Carbonate Solution

Carbonic anhydrase (CA) is an enzyme that catalyzes the reaction of carbon dioxide (CO₂) with water to form carbonic acid (H₂CO₃). When this enzyme is added to an aqueous potassium carbonate (K₂CO₃) solution, two bicarbonate ions (HCO₃⁻) are formed via an acid-base reaction between carbonic acid and carbonate ions (CO₃₂⁻). That is, efforts have been made to apply aqueous K₂CO₃ solutions containing carbonic anhydrase as CO₂ absorbents due to the fact that carbonic anhydrase (CA) enhances the CO₂ absorption rate of aqueous potassium carbonate (K₂CO₃) solution.

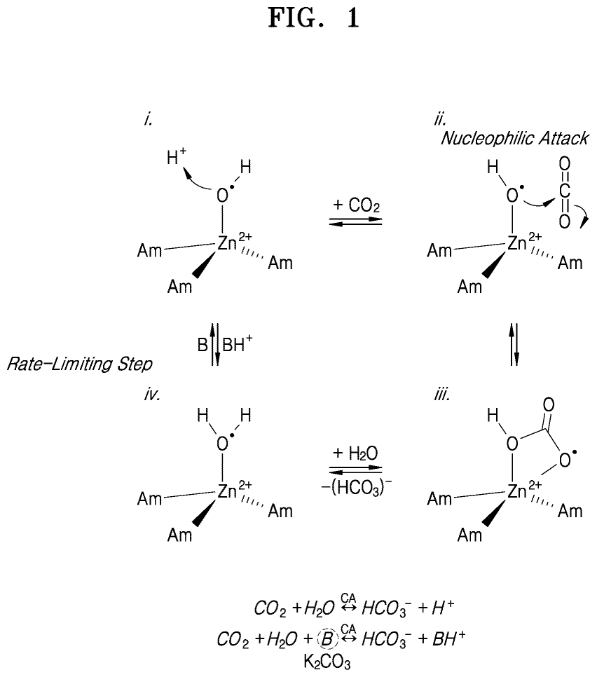

FIG. 1 is a schematic diagram illustrating the reaction mechanism of carbonic anhydrase (CA) according to an embodiment. According to FIG. 1, carbonic anhydrase (CA) has a structure in which one zinc ion (Zn²⁺) per molecule is coordinated with three histidine residues (Am) as ligands. In aqueous solution, carbonic anhydrase (CA) undergoes a reversible reaction in which i. (Am)₃Zn²⁺—OH⁻ binds with CO₂ and converts to ii. (Am)₃Zn²⁺—HCO₃⁻ (Step 1, reaction equation). Then, through nucleophilic attack, ii. (Am)₃Zn²⁺—HCO₃⁻ is reversibly converted to iii. (Am)₃Zn²⁺—HCO₃⁻ intermediate. Upon binding with H₂O, the enzyme is further converted to iv. (Am)₃Zn²⁺—(OH)₂ in a reversible reaction, and upon removal of carbonic acid (B), it regenerates to i. (Am)₃Zn²⁺—OH⁻ in solution (Step 2, reaction equation). At this point, the step in which the intermediate iii. (Am)₃Zn²⁺—HCO₃⁻ is converted to iv. (Am)₃Zn²⁺—(OH)₂ and then back to i. (Am)₃Zn²⁺—OH⁻ is the rate-limiting step of the reaction. This reaction mechanism of carbonic anhydrase (CA) is presented as a reaction equation at the bottom of FIG. 1.

However, as described above, immobilization of carbonic anhydrase is necessary for repeated use in the CA-catalyzed reaction.

When carbonic anhydrase (CA) is immobilized on the surface of a porous polymer membrane by physical adsorption, the enzyme may migrate into the internal pores of the porous substrate during prolonged or repeated use and become easily detached, resulting in loss.

When carbonic anhydrase (CA) is immobilized on the surface of a porous polymer membrane via chemical adsorption, enzyme separation and loss—as observed in physical adsorption—can be prevented. However, the chemical immobilization process requires additional chemicals and energy, and may result in decreased CA activity thereafter.

For example, when the enzyme is immobilized on a silica or polymer-based porous powder substrate, the CO₂ adsorption and desorption must be followed by separating and redistributing the powder, during which agglomeration of the powder and the enzyme, as well as enzyme loss and activity degradation, may be further exacerbated. That is, when carbonic anhydrase (CA) is immobilized on porous powders or their surfaces and used in aqueous potassium carbonate solution for CO₂ capture processes, enzyme loss, deactivation, and aggregation cannot be completely prevented during continuous or repeated operations under high-temperature conditions, which imposes limitations on scale-up.

Additionally, the temperature of the reaction solution is an important factor in improving the CO₂ capture performance of aqueous potassium carbonate solutions using carbonic anhydrase (CA). In general, the reaction in which carbonate ions absorb carbon dioxide and convert it into bicarbonate ions proceeds more rapidly at higher solution temperatures. Since CO₂-containing mixed gas generated in industrial settings typically has a temperature higher than room temperature at the time of generation, the fact that aqueous potassium carbonate solutions have a good reactivity at elevated temperatures is advantageous. Therefore, when using carbonic anhydrase (CA), it is necessary to maintain or enhance CO₂ absorption activity in aqueous potassium carbonate solution at as high a temperature as possible.

According to an embodiment, the carbon dioxide absorbent using an aqueous potassium carbonate solution includes an aqueous potassium carbonate solution including a carbonic anhydrase activity enhancer, and one or more nanoporous structures. The nanoporous structure includes carbonic anhydrase, and the carbonic anhydrase activity enhancer includes a secondary amine compound, which may be present in the aqueous potassium carbonate solution at a concentration of about 20 mM to about 90 mM.

According to an embodiment, the carbon dioxide absorbent is a potassium carbonate-based absorbent using an aqueous potassium carbonate solution as the solvent.

According to an embodiment, the nanoporous structure may have nanoscopic channels with randomly distributed pore sizes that are interconnected in three dimensions. For example, the one or more nanoporous structures may be substrates having a nanoscopic channel structure in which the channel sizes are irregularly distributed from several nanometers to several tens of nanometers and are interconnected in three dimensions. This structure of the nanoporous structure may prevent migration and aggregation of carbonic anhydrase.

According to an embodiment, the nanoporous structure may have a membrane structure. In this specification, the term “membrane” refers to a sheet or film with a thickness of several tens of micrometers that allows permeation of liquids or gases. The membrane structure may take the form of a film or a hollow fiber.

According to an embodiment, in the nanoporous structure, e.g., a covalently bonded structure, carbonic anhydrase is immobilized within the pores. For example, a pressurized enzyme immobilization method may be used to immobilize carbonic anhydrase. The pressurized enzyme immobilization method is a technique in which an enzyme-containing aqueous solution is pressurized and passed through the membrane to immobilize the enzyme within the pores of the membrane. When carbonic anhydrase is immobilized using this pressurized method, the enzyme can be quantitatively loaded, no additional chemicals are required, recovery and reuse are highly convenient, multiple membranes can be used, and the membrane can be manufactured on a large scale.

According to an embodiment, the nanoporous structure may have a structure in which a carbonic anhydrase activity enhancer is grafted onto the inner surface of the pores. For example, the carbonic anhydrase activity enhancer may include a hydrophilic polymer.

In an embodiment, the nanoporous structure may have nanoscopic pores approximately 5 nanometers (nm) to 50 nm in size, which are interconnected in three dimensions, with the internal surfaces of the pores coated with a hydrophilic polymer brush layer. For example, the hydrophilic polymer may include polyethylene glycol (PEG), polypropylene glycol, polyvinyl alcohol, a block copolymer thereof, or a random copolymer thereof. Such a hydrophilic polymer brush layer may stabilize carbonic anhydrase and prevent its denaturation. According to an embodiment, the carbonic anhydrase may include a carbonic anhydrase derived from Bovine Erythrocytes, Thermovibrio ammonificans HB-1, Persephonella marina EX-H1, Sulfurihydrogenibium yellowstonense, Homo sapiens, Bacillus halodurans, Caminibacter mediatlanticus, Bacillus plakortiensis, Codexis DvCA-mutant, Thermococcus onnurineus NA1, or Thalassiosira weissflogii.

According to an embodiment, the carbonic anhydrase activity enhancer may include a secondary amine compound.

For example, the carbonic anhydrase activity enhancer may include at least one of piperazine, N,N′-dimethylethylenediamine, N,N′-diethylethylenediamine, N,N′-diisopropylethylenediamine, N,N′-diisobutylethylenediamine, N,N′-di-tert-butylethylenediamine, N,N′-di-n-butylethylenediamine, monoethanolamine, diethanolamine, diisopropanolamine, 2-piperidineethanol, or morpholine.

According to an embodiment, by including a secondary amine compound in the nanoporous structure, the solubility and diffusivity of carbon dioxide at low temperatures may be improved, and the decline in catalytic reaction rate of the carbonic anhydrase immobilized within the structure may be compensated.

According to an embodiment, the secondary amine compound may be present in the aqueous potassium carbonate solution at a concentration of about 20 mM to about 90 mM. For example, the secondary amine compound may have a concentration of about 22 mM to 88 mM, about 24 mM to about 86 mM, or about 25 mM to 85 mM in the aqueous potassium carbonate solution. If the secondary amine compound has a concentration within the above range, the activity of the carbonic anhydrase may be maximized. Therefore, if a secondary amine compound at such concentrations is included in the nanoporous structure, the amount of carbon dioxide absorbed per mole of potassium carbonate may be significantly increased.

According to an embodiment, the potassium carbonate may be present in the aqueous potassium carbonate solution in an amount of about 5 weight percent (wt %) to about 30 wt %, based on 100 wt % of the total aqueous potassium carbonate solution. For example, the potassium carbonate content may be about 5 wt % to about 28 wt %, about 5 wt % to about 26 wt %, about 5 wt % to about 24 wt %, about 5 wt % to about 22 wt %, about 5 wt % to about 20 wt %, about 5 wt % to about 18 wt %, about 5 wt % to about 16 wt %, or about 5 wt % to about 15 wt %, based on 100 wt % of the total aqueous potassium carbonate solution. When the potassium carbonate content falls within the above range, the partial pressure of carbon dioxide (CO₂) injected as bubbles into the aqueous potassium carbonate solution, diffusing into the interior of the nanoporous covalently bonded structure, in which carbonic anhydrase is immobilized, may increase, thereby promoting the enzymatic reaction of the carbonic anhydrase.

According to an embodiment, the carbon dioxide absorbent using an aqueous potassium carbonate solution may exhibit a carbon dioxide absorption amount of 0.38 mol to 1.0 mol per mole of potassium carbonate at a temperature of 30° C. to 70° C. For example, the carbon dioxide absorbent using an aqueous potassium carbonate solution according to an embodiment may exhibit a carbon dioxide absorption amount of about 0.38 mol to about 0.9 mol, about 0.38 mol to about 0.8 mol, about 0.38 mol to about 0.7 mol, about 0.38 mol to about 0.6 mol, about 0.38 mol to about 0.58 mol, about 0.38 mol to about 0.56 mol, about 0.38 mol to about 0.54 mol, about 0.38 mol to about 0.52 mol, or about 0.38 mol to about 0.50 mol per mole of potassium carbonate.

### Carbon Dioxide Capture Process Using the Carbon Dioxide Absorbent

In another embodiment, the carbon dioxide capture process may include: absorbing a carbon dioxide using a carbon dioxide absorbent based on aqueous potassium carbonate; and desorbing the carbon dioxide using the same absorbent, wherein the carbon dioxide absorbent may include an aqueous potassium carbonate solution including a carbonic anhydrase activity enhancer, and one or more nanoporous structures. The nanoporous structure may include carbonic anhydrase, and the carbonic anhydrase activity enhancer may include a secondary amine compound. The secondary amine compound may be present at a concentration of about 20 mM to about 90 mM in the aqueous potassium carbonate solution.

According to an embodiment, the carbon dioxide capture process may enable carbon dioxide absorption even at elevated temperatures and may provide a process that allows repeated regeneration with minimal change in absorption capacity.

According to an embodiment, the carbon dioxide capture process using the carbon dioxide absorbent includes both a carbon dioxide absorption reaction and a carbon dioxide desorption reaction.

In an embodiment, the carbon dioxide absorption reaction may be carried out at a temperature of 30° C. to 70° C. In an embodiment, the carbon dioxide absorption reaction can maintain high activity even at a high temperature of 70° C. by preventing aggregation of carbonic anhydrase, as compared to an absorption reaction using a CO₂ absorbent that does not contain and does not immobilize carbonic anhydrase in the nanoporous structure.

In an embodiment, the carbon dioxide desorption reaction may be performed at a temperature of 70° C. to 100° C. The carbon dioxide desorption reaction using amine-based absorbents is typically carried out at a temperature of 110° C. to 130° C. During such high-temperature desorption, the amine-based absorbent may partially decompose, generating carcinogenic substances. In contrast, the carbon dioxide desorption reaction according to an embodiment proceeds at a low temperature at or below the boiling point of water (100° C.), significantly reducing energy consumption.

In an embodiment, the nanoporous structure used in the carbon dioxide absorbent may include three-dimensionally interconnected nanoscopic channels of random sizes, with carbonic anhydrase immobilized inside the pores and a polymer grafted to the inner surfaces of the pores which functions as a carbonic anhydrase stabilizer. This structure of the nanoporous structure may prevent migration and aggregation of the carbonic anhydrase. In addition, the carbon dioxide absorbent using the aqueous potassium carbonate solution can be easily recovered and reused, and allows the use of multiple membranes or manufacturing at a large area scale. The carbonic anhydrase stabilizer may include, for example, a hydrophilic polymer.

In an embodiment, the potassium carbonate content may be about 5 wt % to about 30 wt % based on 100 wt % of the total aqueous potassium carbonate solution. When the potassium carbonate content falls within the above range, the partial pressure of carbon dioxide (CO₂) diffusing into the interior of the nanoporous covalently bonded structure, in which carbonic anhydrase is immobilized, may increase, thereby promoting the enzymatic reaction of the carbonic anhydrase.

According to an embodiment, the carbonic anhydrase activity enhancer may include at least one of piperazine, dialkylethylenediamine, monoethanolamine, diethanolamine, diisopropanolamine, 2-piperidineethanol, or morpholine. By including the carbonic anhydrase activity enhancer in the aqueous potassium carbonate solution, the solubility and diffusion of carbon dioxide at low temperatures may be improved, and the supply of carbon dioxide to the nanoporous covalently bonded structure in which the carbonic anhydrase is immobilized may be facilitated.

The process may further include washing the nanoporous structure after performing the carbon dioxide absorption reaction, to allow for reuse of the structure.

The washing may be performed using a buffer solution or water, but is not limited thereto and may employ any cleaning liquid capable of removing carbon dioxide as known in the art.

According to an embodiment, the carbon dioxide capture process may include performing the carbon dioxide absorption reaction as a first cycle, washing the nanoporous structure after the first cycle; immersing the washed structure in a fresh aqueous potassium carbonate solution containing the carbonic anhydrase activity enhancer, and performing the carbon dioxide absorption reaction again, as a second cycle. When the same procedure as in the second cycle is subsequently repeated up to the tenth cycle, the standard deviation (σ) of the relative activity—calculated according to Equation 1 for the amount of carbon dioxide absorbed per mole of potassium carbonate at a temperature of about 30° C. to about 70° C. from the second cycle to the tenth cycle—may fall within +10.

$$Standard deviation of relative activity ( σ ) = \vert [ Ai - \frac{A i}{10} ] \vert \qquad Equation 1$$

and in Equation 1,
Aᵢ may represent a relative activity (%), and

The relative activity (%) may be expressed as

$$[ \frac{\begin{matrix}( Amount of CO 2 absorbed ( mol ) per mole of \\ potassium carbonate in each cycle )\end{matrix}}{\begin{matrix}( Amount of CO 2 absorbed ( mol ) per mole of \\ potassium carbonate in the previous cycle )\end{matrix}} \times 100 ]$$

According to an embodiment, the carbon dioxide capture process using the carbon dioxide absorbent may allow repeated regeneration with minimal change in carbon dioxide absorption capacity at a temperature of about 30° C. to about 70° C.

### Carbon Dioxide Capture System Using the Carbon Dioxide Absorbent

According to another embodiment, the carbon dioxide capture system using the carbon dioxide absorbent may include: an absorber configured to generate a bicarbonate ion (HCO₃⁻)-containing aqueous solution by reacting carbon dioxide contained in exhaust gas with a first carbon dioxide absorbent using an aqueous potassium carbonate solution; and a stripper configured to receive the generated bicarbonate ion-containing aqueous solution through piping connected to the absorber, and to regenerate the solution as a fresh aqueous potassium carbonate solution by separating and removing carbon dioxide through heating or depressurization. The carbon dioxide absorbent may include: an aqueous potassium carbonate solution containing a carbonic anhydrase activity enhancer; and one or more nanoporous covalently bonded structures, wherein the nanoporous structure may include carbonic anhydrase. The carbonic anhydrase activity enhancer may include a secondary amine compound, and the secondary amine compound may be present at a concentration of about 20 mM to about 90 mM in the aqueous potassium carbonate solution.

According to an embodiment, the carbon dioxide capture system using the carbon dioxide absorbent may enable carbon dioxide absorption even at elevated temperatures and may provide a system capable of repeated regeneration with minimal change in carbon dioxide absorption amount.

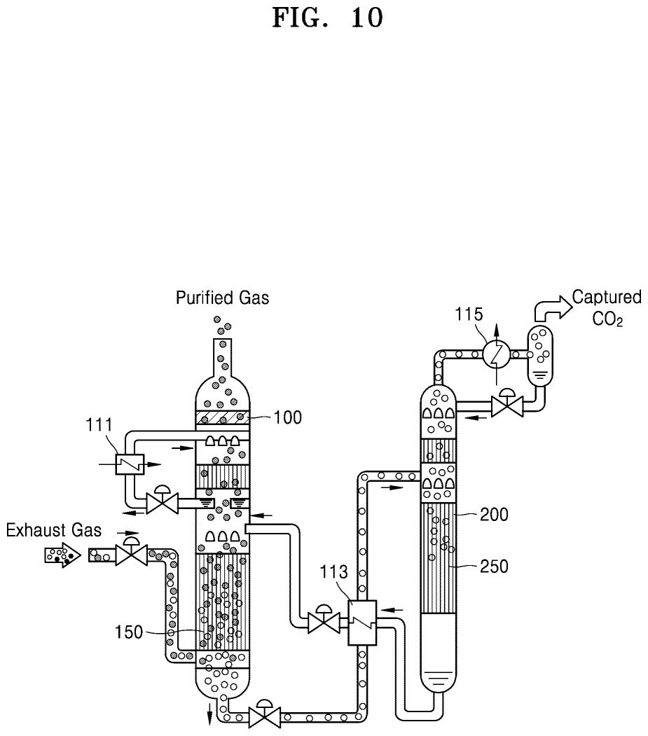

FIG. 10 is a schematic diagram of a carbon dioxide capture system using the carbon dioxide absorbent according to an embodiment.

As shown in FIG. 10, an absorber 100 receives exhaust gas supplied from an external source. The exhaust gas may be carbon dioxide (CO₂)-containing gas generated from sources such as power plants, petrochemical plants, automobiles, or air conditioning systems. The exhaust gas may be introduced into a lower side of the absorber 100 through a gas inlet pipe equipped with a valve. Before being introduced into the absorber, the exhaust gas may optionally pass through a pretreatment column (not shown) that adjusts its temperature and removes impurities.

Inside the absorber 100 is positioned a first carbon dioxide absorbent 150 including an aqueous potassium carbonate solution and one or more nanoporous covalently bonded structures. The nanoporous structure may have a single-layer membrane structure or a multilayer membrane structure. The multilayer membrane structure may include two or more membranes spaced apart and arranged in a horizontal, vertical, or helical configuration. For example, in the aqueous potassium carbonate solution, the nanoporous structure membranes of the first carbon dioxide absorbent 150 may be arranged in a vertically spaced configuration.

The exhaust gas introduced into a lower side of the absorber 100 may contact and react with the first carbon dioxide absorbent 150, allowing carbon dioxide (CO₂) to be absorbed, and discharge the resulting bicarbonate ion (HCO₃⁻)-containing aqueous solution to the lower end of the absorber 100.

The system may further include a heat exchanger 113, positioned between the absorber 100 and the stripper 200, configured to preheat the potassium bicarbonate (HCO₃⁻)-containing aqueous solution generated in the absorber 100 before the solution is transferred to the stripper 200.

The bicarbonate ion (HCO₃⁻)-containing aqueous solution generated at the lower end of the absorber 100 may be pressurized and introduced into the upper portion of the stripper 200 through piping connected to the absorber 100. Pressurization may be carried out using a pump (not shown) or a flow-control valve.

The system may further include a reboiler positioned on a side of the stripper 200 that is opposite the absorber 100 and configured to supply heat to the stripper 200. The reboiler may be directly attached to the lower end of the side of the stripper 200 opposite the absorber 100, or may be disposed at that lower end and connected via piping.

The bicarbonate ion (HCO₃⁻)-containing aqueous solution introduced into the upper portion of the stripper 200 may react with the second carbon dioxide absorbent 250, and the system may further include a collector configured to capture the separated carbon dioxide. Before the separated carbon dioxide is captured, the system may route the carbon dioxide through a condenser 115 connected by piping. The residual gas may be returned via piping to the upper portion of the stripper 200 and then move downward within the stripper 200.

The system may further include a heat exchanger 113, positioned between the absorber 100 and the stripper 200, for recovering heat from the residual gas discharged from the stripper 200. The residual gas that has moved to the lower portion of the stripper 200 passes through the heat exchanger 113, where heat is recovered, and is transferred to the side opposite the gas inlet pipe through which exhaust gas enters the absorber 100. The transferred residual gas may be washed in a washing unit 120 containing a cleaning liquid such as buffer solution or water, and may be discharged as purified gas to the upper portion of the absorber 100. The residual gas washed in the washing unit 120 may also be discharged as purified gas through a cooler 111 connected via piping to the absorber 100.

Hereinbelow, examples and comparative Examples of the present disclosure are described. However, the present disclosure is not limited to the following examples.

### EXAMPLES

### Preparation Example 1: Nanoporous Structure Membrane with Immobilized Carbonic Anhydrase

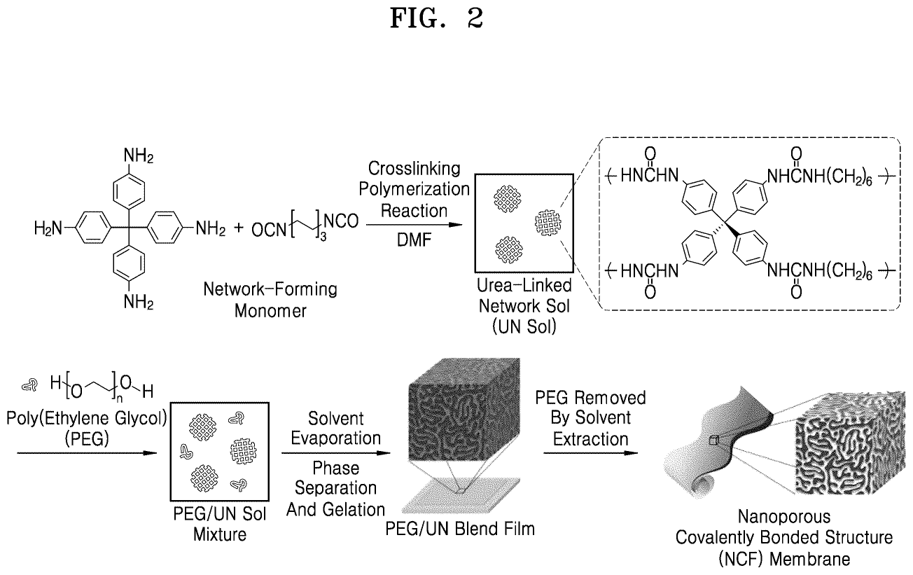

A nanoporous structure was prepared through the following manufacturing process (process shown in FIG. 2). Tetrakis(4-aminophenyl) methane (TAPM) and 1,6-hexamethylene diisocyanate (HDI) were dissolved and stirred in dimethylformamide (DMF) solvent to obtain a urea-linked network (UN) dispersion (sol). Polyethylene glycol (PEG) was dissolved in the urea-linked network (UN) dispersion to obtain a PEG/UN sol mixture. The PEG/UN sol mixture was cast onto a flat substrate, and the solvent was evaporated to yield a PEG/UN blend film. The PEG/UN blend film was removed from the substrate, immersed in water to remove the PEG, and used to fabricate a nanoporous structure membrane, e.g., a covalently bonded structure membrane, having three-dimensionally interconnected nanoscopic channels with random pore sizes of approximately 5 nm to 50 nm, as shown in the lower right portion of FIG. 2.

Nanoporous Structure Membrane with Immobilized Carbonic Anhydrase.

An aqueous solution of carbonic anhydrase (bCA, Sigma Aldrich) was prepared by dispersing bCA in distilled water at a concentration of 30 milligrams per liter (mg/L). The prepared nanoporous structure membrane was mounted in a dead-end filtration cell, and the aqueous solution of carbonic anhydrase was pressurized under nitrogen atmosphere at approximately 3 bar to pass through the membrane, thereby producing a nanoporous structure membrane with immobilized carbonic anhydrase (bCA).

### Comparative Preparation Example 1: Nanoporous Structure Membrane Free of Carbonic Anhydrase and Free of Piperazine

The nanoporous structure membrane was prepared as described in Preparation Example 1.

### Comparative Preparation Example 2: Aqueous Solution of Carbonic Anhydrase Free of Nanoporous Structure

An aqueous solution of carbonic anhydrase (bCA, Sigma Aldrich) was prepared by dispersing bCA in distilled water at a concentration of 30 mg/L, without using any nanoporous structure.

### Comparative Preparation Example 3: Aqueous Solution of Piperazine (PZ) Free of Nanoporous Covalently Bonded Structure

An aqueous potassium carbonate solution containing piperazine (PZ) at a concentration of 30 mM was prepared without using any nanoporous structure.

### Example 1: Carbon Dioxide Absorbent Using Aqueous Potassium Carbonate Solution—wt % K₂CO₃

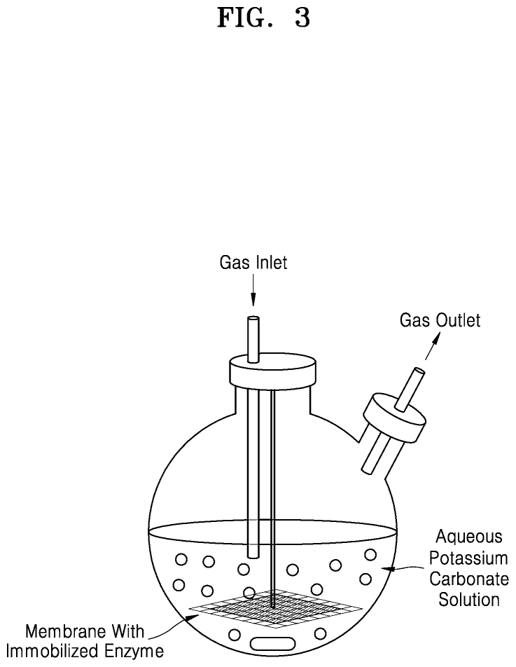

A carbon dioxide absorbent using an aqueous potassium carbonate solution, as illustrated in FIG. 3, was prepared and used as follows. A reactor equipped with a stirrer, gas inlet, and gas outlet was filled with an aqueous potassium carbonate solution containing piperazine at a concentration of 30 millimolar (mM) and approximately 15 wt % potassium carbonate. A nanoporous structure membrane with immobilized carbonic anhydrase (bCA), prepared according to Preparation Example 1, was placed in a mesh holder and immersed in the solution, thereby producing the carbon dioxide absorbent.

### Example 2: Carbon Dioxide Absorbent Using Aqueous Potassium Carbonate Solution—7 wt % K₂CO₃

The carbon dioxide absorbent was prepared in the same manner as in Example 1, except that the solution used was an aqueous potassium carbonate solution containing piperazine at a concentration of 30 mM and approximately 7 wt % potassium carbonate.

### Example 3: Carbon Dioxide Absorbent Using Aqueous Potassium Carbonate Solution—wt % K₂CO₃

The carbon dioxide absorbent was prepared in the same manner as in Example 1, except that the solution used was an aqueous potassium carbonate solution containing piperazine at a concentration of 30 mM and approximately 5 wt % potassium carbonate.

### Example 4: Carbon Dioxide Absorbent Using Aqueous Potassium Carbonate Solution—mM Piperazine (PZ)

The carbon dioxide absorbent was prepared in the same manner as in Example 1, except that the solution used was an aqueous potassium carbonate solution containing piperazine at a concentration of 20 mM and approximately 15 wt % potassium carbonate.

### Example 5: Carbon Dioxide Absorbent Using Aqueous Potassium Carbonate Solution—90 mM Piperazine (PZ)

The carbon dioxide absorbent was prepared in the same manner as in Example 1, except that the solution used was an aqueous potassium carbonate solution containing piperazine at a concentration of 90 mM and approximately 15 wt % potassium carbonate.

### Comparative Example 1: Carbon Dioxide Absorbent Using Aqueous Potassium Carbonate Solution-Free of Nanoporous Covalently Bonded Structure and Free of Piperazine (PZ)

The carbon dioxide absorbent was prepared in the same manner as in Example 1, except that the solution used was the aqueous solution of carbonic anhydrase from Comparative Preparation Example 2, which was free of the nanoporous covalently bonded structure and free of piperazine.

### Comparative Example 2: Carbon Dioxide Absorbent Using Aqueous Potassium Carbonate Solution Containing Piperazine-Free of Nanoporous Covalently Bonded Structure

The carbon dioxide absorbent was prepared in the same manner as in Example 1, except that the solution used was the aqueous potassium carbonate solution containing piperazine from Comparative Preparation Example 3, which was free of the nanoporous structure.

### Comparative Example 3: Carbon Dioxide Absorbent Using Aqueous Potassium Carbonate Solution-Free of Piperazine

The carbon dioxide absorbent was prepared in the same manner as in Example 1, except that the solution used was an aqueous potassium carbonate solution without piperazine.

### Comparative Example 4: Carbon Dioxide Absorbent Using Aqueous Potassium Carbonate Solution-10 mM Piperazine (PZ)

The carbon dioxide absorbent was prepared in the same manner as in Example 1, except that the solution used was an aqueous potassium carbonate solution containing piperazine at a concentration of 10 mM and approximately 15 wt % potassium carbonate.

### Comparative Example 5: Carbon Dioxide Absorbent Using Aqueous Potassium Carbonate Solution-100 mM Piperazine (PZ)

The carbon dioxide absorbent was prepared in the same manner as in Example 1, except that the solution used was an aqueous potassium carbonate solution containing piperazine at a concentration of 100 mM and approximately 15 wt % potassium carbonate.

### Reference Example 1: Aqueous Potassium Carbonate Solution—15 wt % K₂CO₃

In Reference Example 1, an aqueous potassium carbonate solution containing approximately 15 wt % potassium carbonate was filled into a reactor equipped with a stirrer, gas inlet, and gas outlet.

### Reference Example 2: Aqueous Potassium Carbonate Solution+10 mM Piperazine (PZ)

In Reference Example 2, an aqueous potassium carbonate solution containing piperazine at a concentration of 10 mM and approximately 15 wt % potassium carbonate was filled into a reactor equipped with a stirrer, gas inlet, and gas outlet.

### Reference Example 3: Aqueous Potassium Carbonate Solution+20 mM Piperazine (PZ)

In Reference Example 3, an aqueous potassium carbonate solution containing piperazine at a concentration of 20 mM and approximately 15 wt % potassium carbonate was filled into a reactor equipped with a stirrer, gas inlet, and gas outlet.

### Reference Example 4: Aqueous Potassium Carbonate Solution+30 mM Piperazine (PZ)

In Reference Example 4, an aqueous potassium carbonate solution containing piperazine at a concentration of 30 mM and approximately 15 wt % potassium carbonate was filled into a reactor equipped with a stirrer, gas inlet, and gas outlet.

### Reference Example 5: Aqueous Potassium Carbonate Solution+100 mM Piperazine (PZ)

In Reference Example 5, an aqueous potassium carbonate solution containing piperazine at a concentration of 100 mM and approximately 15 wt % potassium carbonate was filled into a reactor equipped with a stirrer, gas inlet, and gas outlet.

### Evaluation Example 1: SEM-EDS Analysis

In Evaluation Example 1, the nanoporous structure membrane prepared in Preparation Example 1 was placed into the lower part of a dead-end filtration cell. An aqueous solution of carbonic anhydrase (bCA, Sigma-Aldrich) was prepared by dispersing bCA in distilled water at a concentration of 24 mg/L and introduced into the upper part of the dead-end filtration cell. While stirring under nitrogen atmosphere, the solution was passed through the membrane under a pressure of approximately 3 bar for 40 hours to produce a nanoporous covalently bonded structure membrane with immobilized bCA. The cross-section of the nanoporous structure membrane with immobilized carbonic anhydrase was analyzed using scanning electron microscopy-energy dispersive X-ray spectroscopy (SEM-EDS).

The SEM-EDS analysis was conducted using the JSM-6700 system from JEOL.

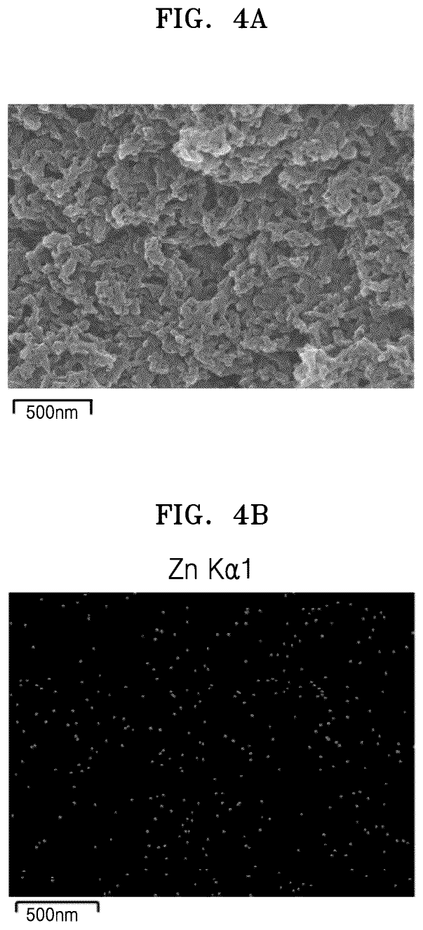

The results are shown in FIGS. 4A and 4B.

As shown in FIG. 4A, the nanoporous structure membrane retained its original porous architecture even after bCA immobilization.

As shown in FIG. 4B, the nanoporous structure membrane was composed of carbon, nitrogen, and oxygen, while bCA contains carbon, nitrogen, oxygen, and zinc. Based on the elemental analysis, the presence of zinc- and thus carbonic anhydrase—was confirmed to be uniformly distributed across the membrane.

### Evaluation Example 2: Quantification of Immobilized CA and Measurement of Membrane Flow Rate

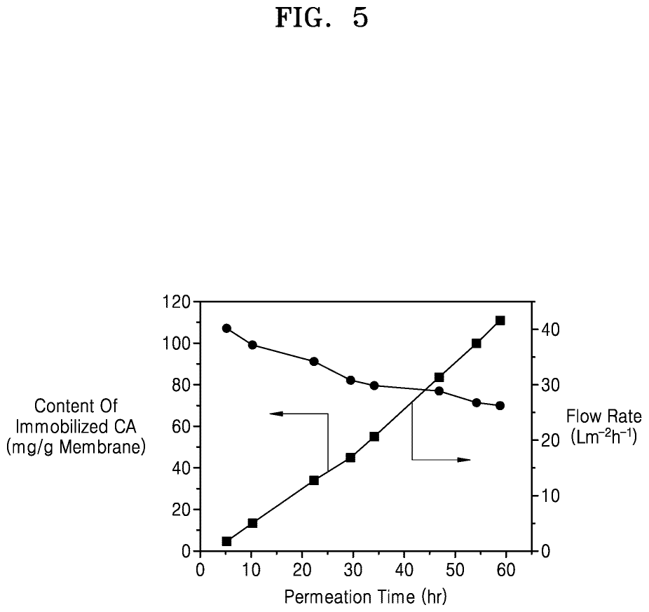

In Evaluation Example 2, nanoporous structure membranes with immobilized carbonic anhydrase were prepared in the same manner as in Evaluation Example 1, except that the aqueous solution of carbonic anhydrase used for immobilization was passed through the membrane for 5 hours, 10 hours, 23 hours, 30 hours, 35 hours, 45 hours, 55 hours, and 60 hours, respectively, to evaluate the effect of permeation time on the amount of carbonic anhydrase immobilized within the nanoporous covalently bonded structure membrane and to measure the flow rate of the membrane during the immobilization process, both the enzyme loading and flow rate were measured using a bicinchoninic acid (BCA) assay kit. The results are shown in FIG. 5.

As shown in FIG. 5, the amount of carbonic anhydrase (bCA) immobilized in the nanoporous structure membrane increased with longer permeation time, while the membrane flow rate decreased.

Evaluation Example 3: CO₂ Absorption Reuse of the Membrane with Immobilized bCA The carbon dioxide absorbent from Example 1 was tested for CO₂ absorption by bubbling a CO₂/N₂ gas mixture (volume ratio=10:90, pressure=1 bar) into the aqueous potassium carbonate solution at 30° C. at a flow rate of 15-20 milliliters per minute (mL/min).

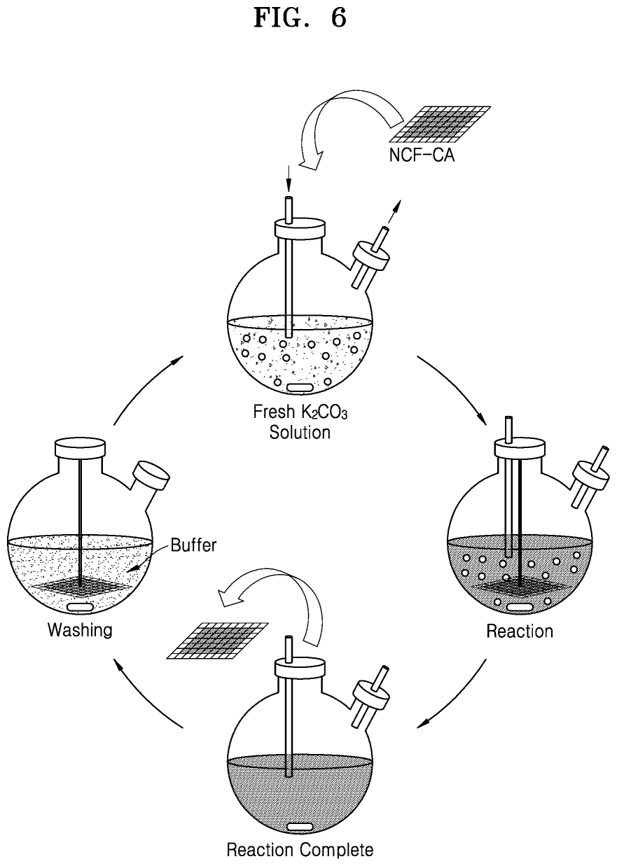

After completion of the CO₂ absorption reaction, the mesh holder containing the nanoporous covalently bonded structure membrane was removed from the reactor. The used nanoporous covalently bonded structure membrane was washed once with a 5 mM phosphate buffer solution. Fresh aqueous potassium carbonate solution was added to the reactor, and the CO₂/N₂ mixture (10:90 by volume, 1 bar) was supplied again under the same conditions to conduct another CO₂ absorption reaction, thereby reusing the carbon dioxide absorbent using the aqueous potassium carbonate solution from Example 1 as illustrated in FIG. 6. This process was repeated for a total of ten cycles.

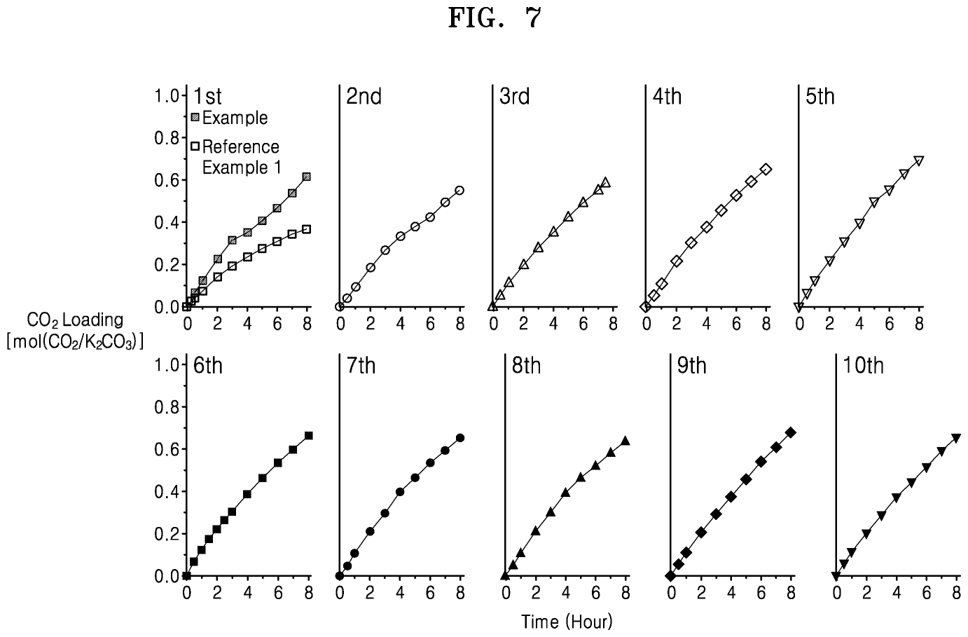

The results are shown in FIG. 7. Based on the 3-hour absorption reaction results in FIG. 7, the relative activity and its standard deviation were calculated using Equation 1, and the results are presented in Table 1.

$$Standard deviation of relative activity ( σ ) = \vert [ Ai - \frac{A i}{10} ] \vert \qquad Equation 1$$

and in Equation 1,
Ai represents relative activity (%), and
   the relative activity (%) is expressed as

$$[ \frac{\begin{matrix}( Amount of CO 2 absorbed ( mol ) per mole of \\ potassium carbonate in each cycle )\end{matrix}}{\begin{matrix}( Amount of CO 2 absorbed ( mol ) per mole of \\ potassium carbonate in the previous cycle )\end{matrix}} \times 100 ]$$

As shown in FIG. 7, even after ten reuse cycles of the carbon dioxide absorbent using the aqueous potassium carbonate solution of Example 1, the amount of carbon dioxide absorbed per mole of potassium carbonate remained nearly constant from the first to the tenth cycle.

TABLE 1

| Item | 1st | 2nd | 3rd | 4th | 5th | 6th | 7th | 8th | 9th | 10th |
|---|---|---|---|---|---|---|---|---|---|---|
| Ai (%) | >99 | 87 | 90 | 97 | >99 | 97 | 96 | 97 | 96 | 94 |
| (Relative activity, %) | | | | | | | | | | |
| $\frac{Ai}{10} ( Average relative activity )$ | 95.2 | | | | | | | | | |
| Standard deviation (σ) | >3.8 | 8.2 | 5.2 | 1.8 | >3.8 | 1.8 | 0.8 | 1.8 | 0.8 | 1.2 |

As shown in Table 1, based on a 3-hour absorption reaction, the relative activity of the carbon dioxide absorbent using the aqueous potassium carbonate solution of Example 1 was maintained at or above 87% across ten cycles, and the standard deviation of the relative activity remained at or below 8.2.

### Evaluation Example 4: CO₂ Absorption Capacity Per Mole of K₂CO₃ at Different Temperatures

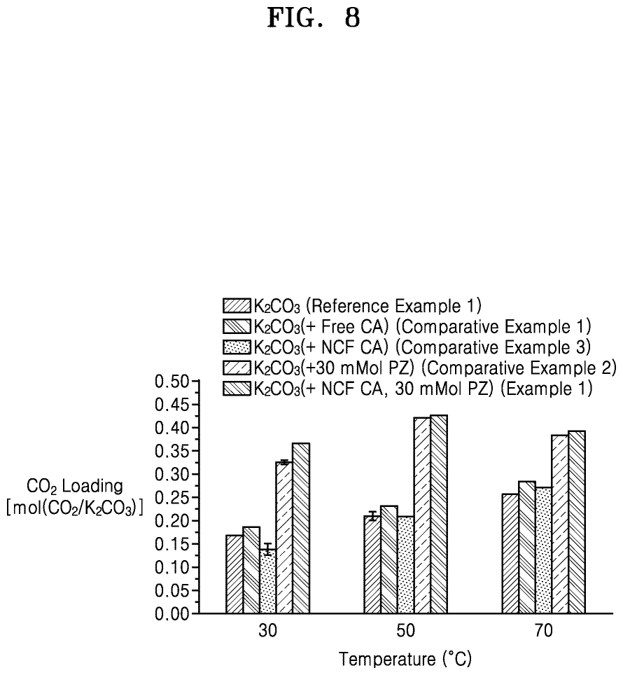

CO₂ absorption tests were performed using the aqueous potassium carbonate solution of Reference Example 1, the carbon dioxide absorbents using the aqueous potassium carbonate solutions of Comparative Examples 1 to 3, and the carbon dioxide absorbent using the aqueous potassium carbonate solution of Example 1. At 30° C., 50° C., or 70° C., a CO₂/N₂ gas mixture (volume ratio=10:90, pressure=1 bar) was bubbled into each solution at a rate of 15-20 mL/min for 2 hours, and the amount of carbon dioxide absorbed per mole of potassium carbonate during the initial two hours was measured. In all cases, the concentration of carbonic anhydrase was adjusted to 30 mg/L, regardless of whether it was immobilized. The piperazine concentration was fixed at 30 mM. The results are shown in FIG. 8.

As shown in FIG. 8, the carbon dioxide absorbent using the aqueous potassium carbonate solution of Example 1 exhibited a higher amount of CO₂ absorbed per mole of potassium carbonate at 30° C., 50° C., and 70° C. compared to the aqueous potassium carbonate solution of Reference Example 1 and the carbon dioxide absorbents of Comparative Examples 1 to 3. Among the tested temperatures, the carbon dioxide absorbent of Example 1 showed the highest CO₂ absorption per mole of potassium carbonate at 50° C.

In contrast, the aqueous potassium carbonate solution without carbonic anhydrase (Reference Example 1) exhibited an increase in CO₂ absorption per mole of potassium carbonate as the temperature increased during the initial two hours. That is, it was confirmed that the CO₂ absorption rate of the potassium carbonate solution without carbonic anhydrase (Reference Example 1) improved with increasing temperature.

The carbon dioxide absorbent using a potassium carbonate solution containing non-immobilized carbonic anhydrase (Comparative Example 1) exhibited higher activity compared to the solution without carbonic anhydrase (Reference Example 1), although the trend with respect to temperature was similar. However, the carbon dioxide absorbent using potassium carbonate solution containing non-immobilized carbonic anhydrase (Comparative Example 1) could not be reused due to depletion of the carbonic anhydrase.

The carbon dioxide absorbent using potassium carbonate solution with immobilized carbonic anhydrase but without piperazine (Comparative Example 3) showed a lower amount of CO₂ absorbed per mole of potassium carbonate at 30° C. compared to the solution without carbonic anhydrase (Reference Example 1). This is believed to result from the hydrophilic polymer PEG present in the nanoporous covalently bonded structure membrane slowing the carbonation reaction. The CO₂ absorption amount was also lower compared to the absorbent of Comparative Example 1, which contained non-immobilized carbonic anhydrase. At 50° C., Comparative Example 3 also showed lower CO₂ absorption per mole of potassium carbonate compared to Reference Example 1 and Comparative Example 1. However, the activity of Comparative Example 3 continued to increase as the temperature was raised from 30° C. to 50° C. and 70° C. This is believed to result from enhanced material movement between the interior and exterior of the nanoscopic channels in Comparative Example 3 due to the increase in temperature, thereby increasing the amount of CO₂ absorbed per mole of potassium carbonate.

The carbon dioxide absorbent using an aqueous potassium carbonate solution containing piperazine but without carbonic anhydrase (Comparative Example 2) showed a significant increase in CO₂ absorption per mole of potassium carbonate, compared to Comparative Example 1 (the carbon dioxide absorbent without immobilized carbonic anhydrase) and Comparative Example 3 (the carbon dioxide absorbent with immobilized carbonic anhydrase but without piperazine). However, as described above, the CO₂ absorption per mole of potassium carbonate was still lower than that of the carbon dioxide absorbent of Example 1, which included both immobilized carbonic anhydrase and piperazine. This suggests that piperazine not only increases the reactivity of the potassium carbonate solution but also facilitates material movement toward the enzyme immobilized within the nanopores.

### Evaluation Example 5: CO₂ Absorption Per Mole of K₂CO₃ as a Function of Secondary Amine Compound Concentration

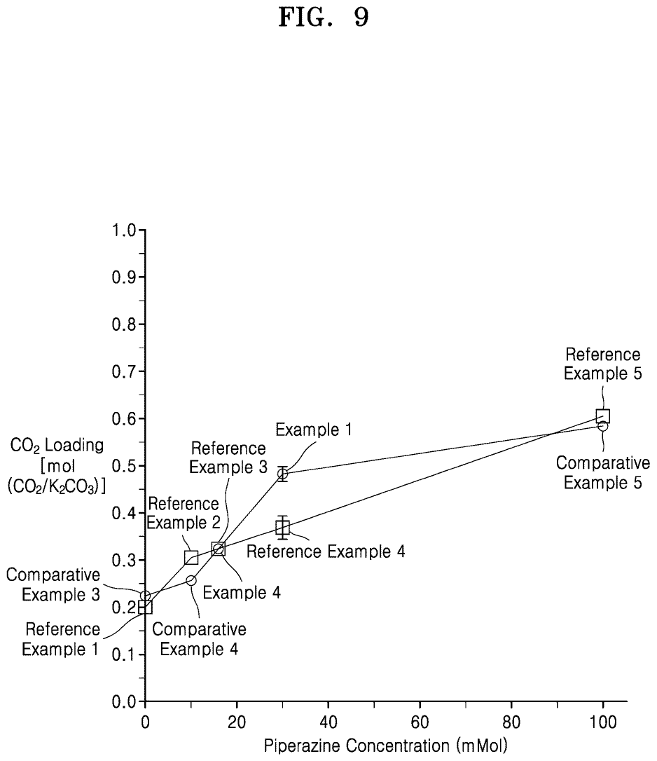

CO₂ absorption tests were conducted using the aqueous potassium carbonate solutions of Reference Examples 1 to 5; the carbon dioxide absorbents using the aqueous potassium carbonate solutions of Comparative Examples 3 to 5; the carbon dioxide absorbent using the aqueous potassium carbonate solution of Example 1; and the carbon dioxide absorbent using the aqueous potassium carbonate solution of Example 4. A CO₂/N₂ gas mixture (volume ratio=10:90, pressure=1 bar) was bubbled into each solution at a rate of 15-20 mL/min for 2 hours at 30° C., and the amount of carbon dioxide absorbed per mole of potassium carbonate during the initial two hours was measured. The results are shown in FIG. 9.

As shown in FIG. 9, the carbon dioxide absorbents using the aqueous potassium carbonate solutions of Example 1 and Example 4 exhibited comparable or improved CO₂ absorption per mole of potassium carbonate during the initial two hours, compared to the carbon dioxide absorbents using the aqueous potassium carbonate solutions of Reference Examples 1 to 5 and Comparative Examples 3 to 5.

Specifically, in the aqueous potassium carbonate solutions without carbonic anhydrase, the amount of CO₂ absorbed per mole of potassium carbonate during the initial two hours increased proportionally with the concentration of the secondary amine compound piperazine, except at very low concentrations.

The carbon dioxide absorbents using aqueous potassium carbonate solutions containing piperazine at concentrations of 20 mM to 90 mM showed CO₂ absorption amounts per mole of potassium carbonate during the initial two hours that were comparable to or greater than those of the carbon dioxide absorbents using the aqueous potassium carbonate solutions of Reference Examples 1 to 5 and Comparative Examples 3 to 5. These results confirm that the secondary amine compound piperazine exhibits carbonic anhydrase activity enhancement within the aforementioned concentration range.

The carbon dioxide absorbent using an aqueous potassium carbonate solution according to one aspect may include an aqueous potassium carbonate solution containing a carbonic anhydrase activity enhancer and one or more nanoporous covalently bonded structures. The nanoporous covalently bonded structure may include carbonic anhydrase, the carbonic anhydrase activity enhancer may include a secondary amine compound, and the secondary amine compound may be present at a concentration of about 20 mM to about 90 mM in the aqueous potassium carbonate solution. The carbon dioxide absorbent using the aqueous potassium carbonate solution enables carbon dioxide absorption even at elevated temperatures and allows repeated regeneration with minimal change in the carbon dioxide absorption capacity.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A carbon dioxide absorbent using an aqueous potassium carbonate solution, the carbon dioxide absorbent comprising:
the aqueous potassium carbonate solution including a carbonic anhydrase activity enhancer; and
one or more nanoporous structures, wherein the one or more nanoporous structures comprise carbonic anhydrase;
wherein the carbonic anhydrase activity enhancer comprises a secondary amine compound, and the secondary amine compound is present in the aqueous potassium carbonate solution at a concentration of about 20 millimolar to about 90 millimolar.

2. The carbon dioxide absorbent of claim 1,
wherein the potassium carbonate is present in the aqueous potassium carbonate solution in an amount of about 5 weight percent to about 30 weight percent, based on 100 weight percent of the aqueous potassium carbonate solution.

3. The carbon dioxide absorbent of claim 1,
wherein the one or more nanoporous structures comprise a three-dimensionally interconnected nanochannel network having pores of random size, and the anhydrase activity enhancer is grafted onto an inner surface of the pores.

4. The carbon dioxide absorbent of claim 1,
wherein the one or more nanoporous structure includes carbonic anhydrase immobilized in pores of the one or more nanoporous structures.

5. The carbon dioxide absorbent of claim 4,
wherein the carbonic anhydrase activity enhancer comprises a hydrophilic polymer, and the carbonic anhydrase activity enhancer is grafted to inner surfaces of the pores.

6. The carbon dioxide absorbent of claim 5,
wherein the hydrophilic polymer comprises polyethylene glycol, polypropylene glycol, polyvinyl alcohol, a block copolymer of a least two of the foregoing, or a random copolymer of at least two of the foregoing.

7. The carbon dioxide absorbent of claim 1,
wherein the carbonic anhydrase is derived from Bovine Erythrocytes, Thermovibrio ammonificans HB-1, Persephonella marina EX-H1, Sulfurihydrogenibium yellowstonense, Homo sapiens, Bacillus halodurans, Caminibacter mediatlanticus, Bacillus plakortiensis, Codexis DvCA-mutant, Thermococcus onnurineus NA1, or Thalassiosira weissflogii.

8. The carbon dioxide absorbent of claim 1,
wherein the carbonic anhydrase activity enhancer comprises at least one of piperazine, N,N′-dimethylethylenediamine, N,N′-diethylethylenediamine, N,N′-diisopropylethylenediamine, N,N′-diisobutylethylenediamine, N,N′-di-tert-butylethylenediamine, N,N′-di-n-butylethylenediamine, monoethanolamine, diethanolamine, diisopropanolamine, 2-piperidineethanol, or morpholine.

9. The carbon dioxide absorbent of claim 1,
wherein, during an initial two hours of absorption, the carbon dioxide absorbent absorbs carbon dioxide at an amount of about 0.38 mol to about 1.0 mol per mole of potassium carbonate at a temperature of about 30° C. to about 70° C.

10. A carbon dioxide capture process using a carbon dioxide absorbent, the process comprising:
absorbing carbon dioxide using a carbon dioxide absorbent; and
desorbing the carbon dioxide from the carbon dioxide absorbent,
wherein the carbon dioxide absorbent comprises:
an aqueous potassium carbonate solution including a carbonic anhydrase activity enhancer; and
one or more nanoporous structures, wherein the one or more nanoporous structures comprise carbonic anhydrase,
wherein the carbonic anhydrase activity enhancer comprises a secondary amine compound, and the secondary amine compound is present in the aqueous potassium carbonate solution at a concentration of about 20 millimolar to about 90 millimolar.

11. The carbon dioxide capture process of claim 10,
wherein the carbon dioxide is absorbed at a temperature of about 30° C. to about 70° C., and the carbon dioxide is desorbed at a temperature of about 70° C. to about 100° C.

12. The carbon dioxide capture process of claim 10,
wherein the carbonic anhydrase activity enhancer comprises at least one of piperazine, N,N′-dimethylethylenediamine, N,N′-diethylethylenediamine, N,N′-diisopropylethylenediamine, N,N′-diisobutylethylenediamine, N,N′-di-tert-butylethylenediamine, N,N′-di-n-butylethylenediamine, monoethanolamine, diethanolamine, diisopropanolamine, 2-piperidineethanol, or morpholine.

13. The carbon dioxide capture process of claim 10,
wherein the absorbing of the carbon dioxide, during an initial two hours of absorption, the carbon dioxide absorbent absorbs carbon dioxide at an amount of about 0.38 mol to about 0.60 mol per mole of potassium carbonate at a temperature of about 30° C. to about 70° C.

14. The carbon dioxide capture process of claim 10, further comprising washing the one or more nanoporous structures after absorbing the carbon dioxide to facilitate reuse of the structures.

15. The carbon dioxide capture process of claim 10, further comprising
absorbing the carbon dioxide as a first cycle;
washing the one or more nanoporous structure after the first cycle to provide a washed structure;
immersing the washed structure in a fresh aqueous potassium carbonate solution containing the carbonic anhydrase activity enhancer; and
repeating the absorption of the carbon dioxide as a second cycle, wherein the same procedure as in the second cycle is subsequently repeated up to a tenth cycle,
wherein a standard deviation (o) of relative activity, as calculated by Equation 1 for an amount of carbon dioxide absorbed per mole of potassium carbonate at a temperature of about 30° C. to about 70° C. from the second cycle to the tenth cycle, is within ±10:
$$Standard deviation of relative activity ( σ ) = \vert [ Ai - \frac{A i}{10} ] \vert \qquad Equation 1$$
wherein in Equation 1,
Ai represents relative activity (%), and
the relative activity (%) is expressed as
$$[ \frac{\begin{matrix}( Amount of CO 2 absorbed ( mol ) per mole of \\ potassium carbonate in each cycle )\end{matrix}}{\begin{matrix}( Amount of CO 2 absorbed ( mol ) per mole of \\ potassium carbonate in the previous cycle )\end{matrix}} \times 100 ]$$

16. A carbon dioxide capture system using a carbon dioxide absorbent, the system comprising:
an absorber configured to generate bicarbonate ion-upon contact with carbon dioxide in an exhaust gas and including a first carbon dioxide absorbent comprising an aqueous potassium carbonate solution; and
a stripper configured to receive the generated bicarbonate ion, the stripper connected to the absorber, wherein the stripper separates the carbon dioxide from the absorber by heating and/or depressurization, and regenerates the aqueous potassium carbonate solution;
wherein the carbon dioxide absorbent comprises:
the aqueous potassium carbonate solution including a carbonic anhydrase activity enhancer; and
one or more nanoporous structures, wherein the one or more nanoporous structures comprise carbonic anhydrase,
wherein the carbonic anhydrase activity enhancer comprises a secondary amine compound, and the secondary amine compound is present in the aqueous potassium carbonate solution at a concentration of about 20 millimolar to about 90 millimolar.

17. The system of claim 16,
wherein the one or more nanoporous structure has a single-layer membrane structure or a multilayer membrane structure, wherein the multilayer membrane structure comprises two or more membranes spaced apart in a horizontal, vertical, or helical configuration.

18. The system of claim 16, further comprising a reboiler configured to supply heat to the stripper.

19. The system of claim 16, further comprising a collector configured to capture the carbon dioxide separated in the stripper.

20. The system of claim 16,
further comprising a heat-exchanger positioned between the absorber and the stripper and configured to preheat the potassium bicarbonate-containing aqueous solution generated in the absorber, before the potassium bicarbonate-containing aqueous solution is transferred to the stripper.
